(19) United States
(12) Patent Application Publication
(10) Pub. No.: US 2022/0272946 A1
(43) Pub. Date: Sep. 1, 2022

(54) PET TOY

(71) Applicant: Doskocil Manufacturing Company, Inc., Arlington, TX (US)

(72) Inventors: Jill JACKSON, Fort Worth, TX (US); Ronald BAGLEY, Dallas, TX (US); Sunil PINTO, Arlington, TX (US); Josiah WILHELM, Fort Worth, TX (US)

(21) Appl. No.: 17/487,672

(22) Filed: Sep. 28, 2021

Related U.S. Application Data
(60) Provisional application No. 63/154,213, filed on Feb. 26, 2021.

(51) Int. Cl. A01K 15/02

(52) U.S. Cl. CPC A01K 15/026

(57) ABSTRACT

A pet toy includes a housing and a core. The housing has at least one pocket that is located on an interior wall of the housing. The core is housed in the housing. The core is movable with respect to the housing between an aligned position with the housing and an unaligned position. The core is disposed in front of the pocket in the aligned position. The core is offset from the pocket in the unaligned position.

### CROSS-REFERENCE TO RELATED APPLICATIONS

This application claims priority to Provisional U.S. Patent Application No. 63/154,213, filed on Feb. 26, 2021. The entire disclosure of Provisional U.S. Patent Application No. 63/154,213 is hereby incorporated by reference.

### BACKGROUND

### Field of the Invention

The present invention generally relates to a pet toy. More specifically, the present invention relates to a pet toy that is a chew toy.

### Background Information

It is estimated that over two-thirds of dogs over the age of three have periodontal disease, an inflammation or infection of the tissues surrounding the teeth. Periodontal disease starts as gingivitis caused by plaque and often progresses to involve the bony tooth sockets. Left untreated, periodontal disease can lead to painful tooth loss. Veterinarians recommend brushing dogs' teeth daily to prevent infections and gum disease. Some conventional chew toys are designed as toothbrush replacements and attempt to maintain a dog's interest long enough for their teeth to be cleaned and for ease of cleaning after use.

### SUMMARY

It has been determined that brushing a dog's teeth may be tedious and dangerous if a dog is not agreeable. In view of the state of the known technology, one aspect of the present disclosure is to provide a pet toy comprising a housing and a core. The housing has at least one pocket that is located on an interior wall of the housing. The core is housed in the housing. The core is movable with respect to the housing between an aligned position with the housing and an unaligned position. The core is disposed in front of the pocket in the aligned position so to restrict the pocket from access. The core is offset from the pocket in the unaligned position.

In a second aspect of the pet toy in accordance with the first aspect, the housing includes a central opening that defines the interior wall. The core is movably disposed in the central opening.

In a third aspect of the pet toy in accordance with the second aspect, the housing forms an outer rim around the core.

In a fourth aspect of the pet toy in accordance with the first aspect, the housing and the core are both deformable.

In a fifth aspect of the pet toy in accordance with the fourth aspect, the housing is made of vulcanized rubber, and the core is made of vulcanized rubber.

In a sixth aspect of the pet toy in accordance with the first aspect, the housing includes a pair of pockets that are disposed on opposite sides of the central opening with respect to each other.

In a seventh aspect of the pet toy in accordance with the second aspect, the housing has a rod extending through the central opening that engages with the core.

In an eighth aspect of the pet toy in accordance with the seventh aspect, the core has a through hole. The rod extends through the through hole so that the core rotatable with respect to the housing about the rod.

In a ninth aspect of the pet toy in accordance with the eighth aspect, the rod includes an annular flange. The through hole of the core includes an annular depression that engages with the annular flange.

In a tenth aspect of the pet toy in accordance with the first aspect, the core includes a plurality of protrusions projecting from at least one outer surface of the core.

In an eleventh aspect of the pet toy in accordance with the first aspect, the core includes a plurality of indents disposed on at least one outer surface of the core.

In a twelfth aspect of the pet toy in accordance with the first aspect, the core includes a plurality of protrusions projecting from a first outer surface of the core.

In a thirteenth aspect of the pet toy in accordance with the twelfth aspect, the plurality of protrusions face the at least one pocket when the core is in the aligned position with the housing.

In a fourteenth aspect of the pet toy in accordance with the twelfth aspect, the core includes a plurality of indents disposed on a second outer surface of the core.

In a fifteenth aspect of the pet toy in accordance with the fourteenth aspect, the second outer surface faces away from the at least one pocket when the core is in the aligned position with the housing.

In a sixteenth aspect of the pet toy in accordance with the second aspect, the housing includes at least one groove extending around the central opening.

In a seventeenth aspect of the pet toy, a method of forming a pet toy comprises molding a housing from vulcanized rubber. The housing has at least one pocket that is located on an interior wall of the housing. The method further comprises molding a core from vulcanized rubber. The method further comprises installing the core to the housing to dispose the core inside the housing to be movable with respect to the housing between an aligned position with the housing and an unaligned position. The core is disposed in front of the pocket to obstruct external access to the pocket in the aligned position. The core is offset from the pocket in the unaligned position.

Embodiments of the invention described herein provide a suitable alternative to a tooth brush for cleaning a dog's tooth. Embodiments of the present invention have a unique structure and configuration to not only clean teeth but to maintain a dog's interest long enough for their teeth to be cleaned and for ease of cleaning after use.

### BRIEF DESCRIPTION OF THE DRAWINGS

Referring now to the attached drawings which form a part of this original disclosure:

FIG. 1 is a top perspective view of a pet toy in accordance with an illustrated embodiment;

FIG. 2 is a bottom perspective view of the pet toy of FIG. 1;

FIG. 3 is a front elevational view of the pet toy of FIGS. 1 and 2;

FIG. 4 is a top perspective view of the pet toy of FIGS. 1 to 3 having a core that is unaligned from a housing;

FIG. 5 is a top perspective view of the pet toy showing the core further unaligned from the housing to show a pocket of the pet toy;

FIG. 6 is a cross-sectional view of the pet toy;

FIG. 7 is an elevational view of the core of the pet toy; and

FIG. 8 is an elevational view of the housing of the pet toy.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

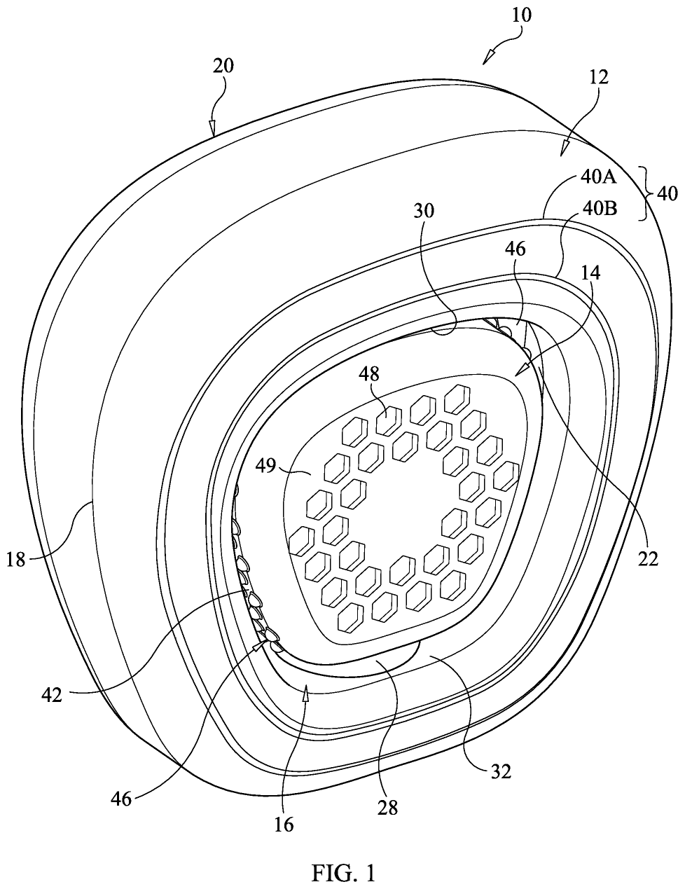

Referring initially to FIGS. 1 to 5, a pet toy 10 comprises a housing 12 and a core 14 in accordance with an illustrated embodiment. The housing 12 forms an outer rim around the core 14. In particular, the housing 12 includes a central opening 16 that is at least partially defined by a pair of interior walls 22 of the housing 12. The housing 12 further includes an exterior wall 18 that forms the outer rim around the core 14. The exterior wall 18 of the housing 12 defines an exterior wall 18 of the pet toy 10.

The core 14 is disposed in the central opening 16 of the housing 12. That is, the housing 12 does not encase the core 14 in the illustrated embodiment. Rather, the core 14 is supported by the housing 12 such that the core 14 is readily accessible for a pet's engagement. Alternatively speaking, the core 14 can be housed in the housing 12 in a manner such that the core 14 can be chewed and played with by a pet while the core 14 is in the housing 12. The central opening 16 has an outer perimeter that is larger than an outer perimeter of the core 12 so that the core 14 is spaced from the housing. Therefore, the housing 12 is preferably spaced from the core 14 so that the core 14 has room within the housing 12 to be movable with respect to the housing 12.

In the illustrated embodiment, the housing 12 and the core 14 together form the pet toy 10 that is deformable and designed to be chewed by the pet for prolonged engagement. For example, the housing 12 and the core 14 are both preferably made of a durable and resilient material that is also deformable and has elastic properties so that it retains its shape and overall structure over repeated use. In the illustrated embodiment, the housing 12 is preferably made of vulcanized rubber molded to have an apple shape. In the illustrated embodiment, the core 14 is also preferably made of vulcanized rubber molded to have an apple core shape.

As shown, the housing 12 and the core 14 are designed to mimic the appearance and shape of an apple for the pet's amusement. However, it will be apparent to those skilled in the pet products field from this disclosure that the housing 12 and the core 14 can mimic the appearance of other objects, such as different types of fruit, and be formed from any suitable material.

In the illustrated embodiment, the pet toy 10 enables cleaning of the pet's teeth and/or gums during use of the pet toy 10. That is, the pet toy 10 can be an alternative to a toothbrush for a pet, and is further designed and configured to maintain the pet's interest for a longer duration so that the teeth can be cleaned more thoroughly. Therefore, the pet toy 10 is a textured toy with abutments, protrusions, nubs, indentations and raised surfaces for rubbing against a dog's teeth to clean the teeth.

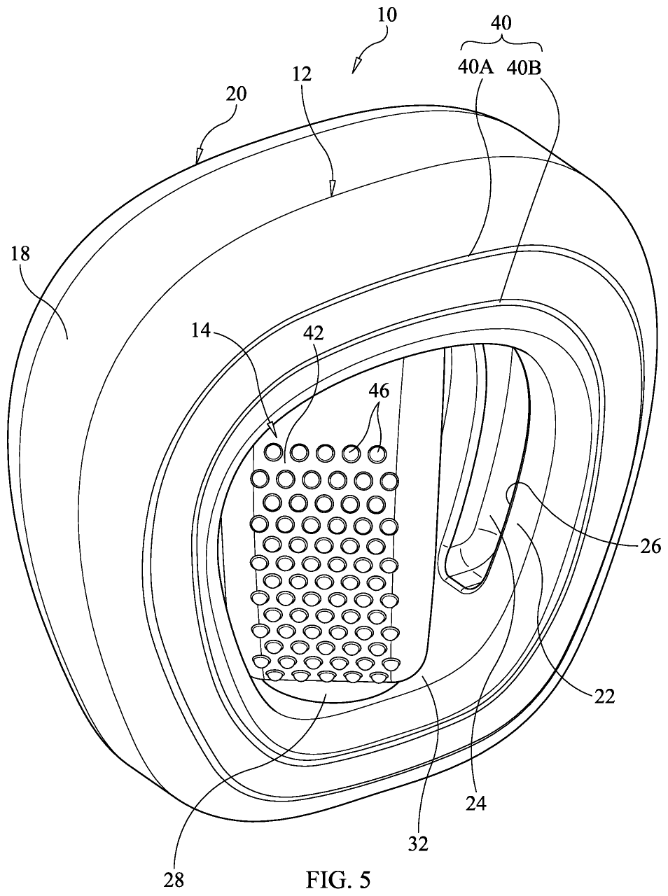

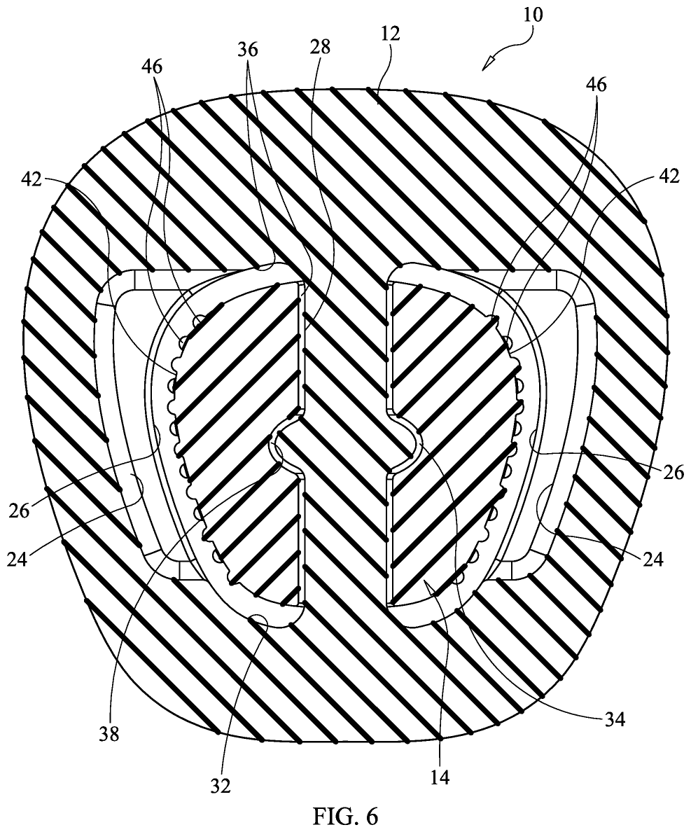

Further, the pet toy 10 includes one or more openings or pockets 24 (e.g., the pockets 24), as best seen in FIGS. 5 and 6. The pockets 24 are provided for storing toothpaste that can be extracted or ooze from the pockets 24 when the dog chews or plays with the pet toy 10, as will be described below. The pockets 24 are also designed for easy cleaning by enabling the core 14 to be movable about the housing 12.

For example, as best seen in FIGS. 1 to 5, the exterior wall 18 of the housing 12 has one or more exterior surfaces 20. The housing 12 further includes a pair of interior walls 22, as best seen in FIGS. 5, 6 and 8. The interior wall faces the core 14 and the exterior surfaces 20 define an exterior of the housing 12. The exterior surfaces 20 are angled and curved to resemble an outline of an apple. The housing 12 includes at least one pocket 24. Preferably, the housing 12 includes a pair of pockets 24 that are located on the opposite interior walls 22 of the housing 12, as seen in FIG. 6. Therefore, the pockets 24 are on opposite sides of the housing 12 with respect to each other.

The pockets 24 can contain cleaning agents (e.g., toothpaste) and/or foodstuffs (e.g., peanut butter, treats, etc.). As shown, the pockets 24 preferably have elongated openings 26 located on the interior walls 22 of the housing 12. However, it will be apparent to those skilled in the pet products field from this disclosure that the housing 12 can include a plurality of pockets 24 of different lengths, dimensions and orientations along the interior walls 22 and/or other locations on the pet toy 10.

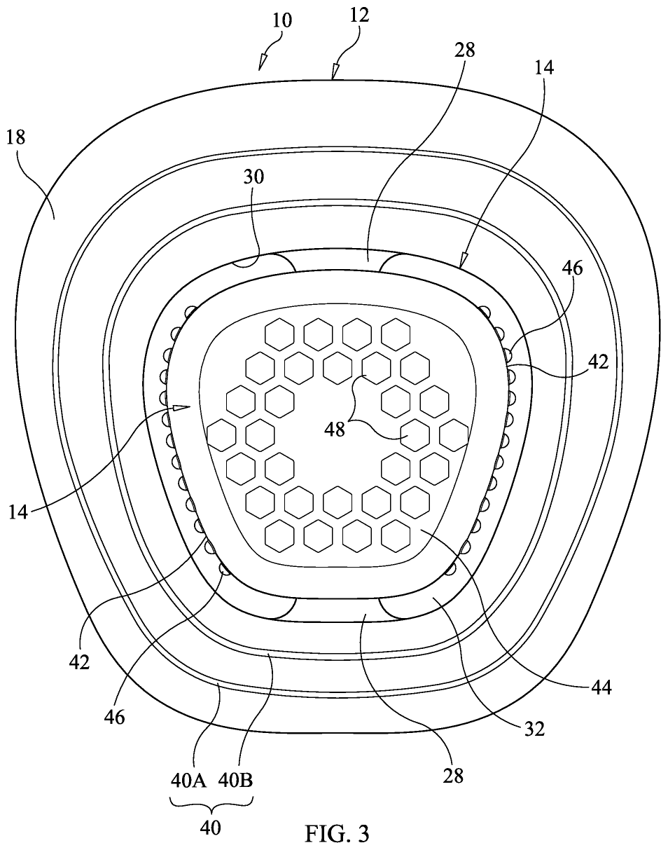

Thus, in the illustrated embodiment, the pockets 24 are pockets 24 when the core 14 is in front of the pocket 24 to restrict the pocket 24 from access, as seen in FIGS. 1 and 3. In this condition of the pet toy 10, the pet can still smell any cleaning agents and/or foodstuffs contained in the pockets 24. The pockets 24 are more accessible when the core 14 moves to reveal cleaning agents and/or foodstuffs, as seen in FIG. 5. With this arrangement, the pet toy 10 acts as a puzzle for the pet when trying to retrieve treats from the pockets 24. That is, when the core 14 rotates into and out of alignment with the housing 12, the pet toy 10 is designed as a puzzle for the dog to engage to try to access the treats stored in the pockets 24.

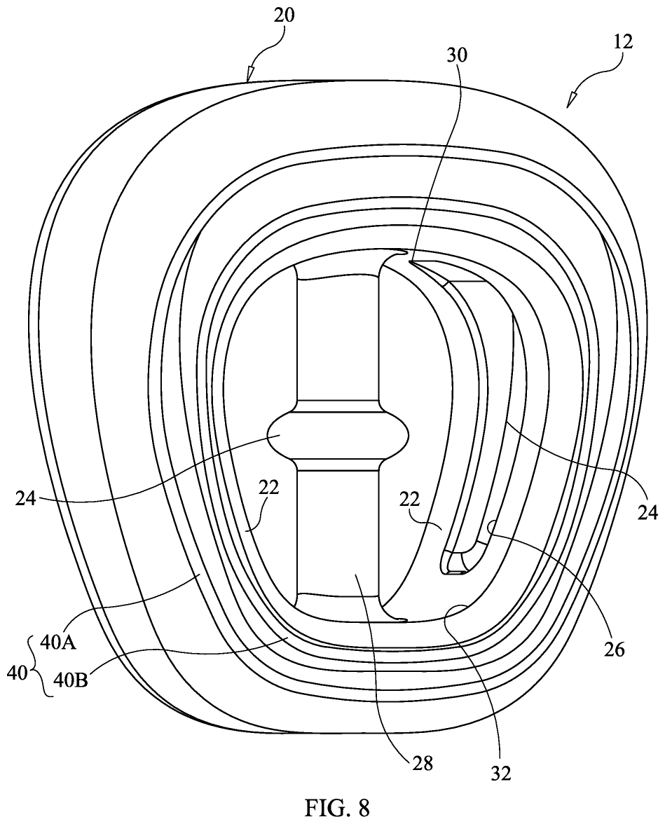

As best seen in FIGS. 6 and 8, the housing 12 has a rod 28 extending through the central opening 16 and through the core 14. The central opening 16 includes a top wall 30 and a bottom wall 32 that are connected by the interior walls 22. That is, the central opening 16 is defined by the top wall 30, the bottom wall 32 and the interior walls 22. The interior walls 22 are lateral walls of the central opening 16. The rod 28 extends from the top and bottom walls 30 and 32 of the housing 12. The core 14 is movably connected to the housing 12 by the rod 28.

As best seen in FIGS. 6 and 8, the rod 28 includes an annular flange 34. The core 14 engages the annular flange 34, as seen in FIG. 6. In particular, the core 14 preferably includes a through hole 36 that receives the rod 28 of the housing 12. The through hole 36 of the core 14 includes an annular depression 38 that receives the annular flange 34 of the rod 28. Preferably, the annular flange 34 of the rod 28 is received by the annular depression 38 by interference fit so that the core 14 is not sliding up and down along the rod 28. Therefore, the core 14 and the housing 12 are frictionally engaged via the rod 28.

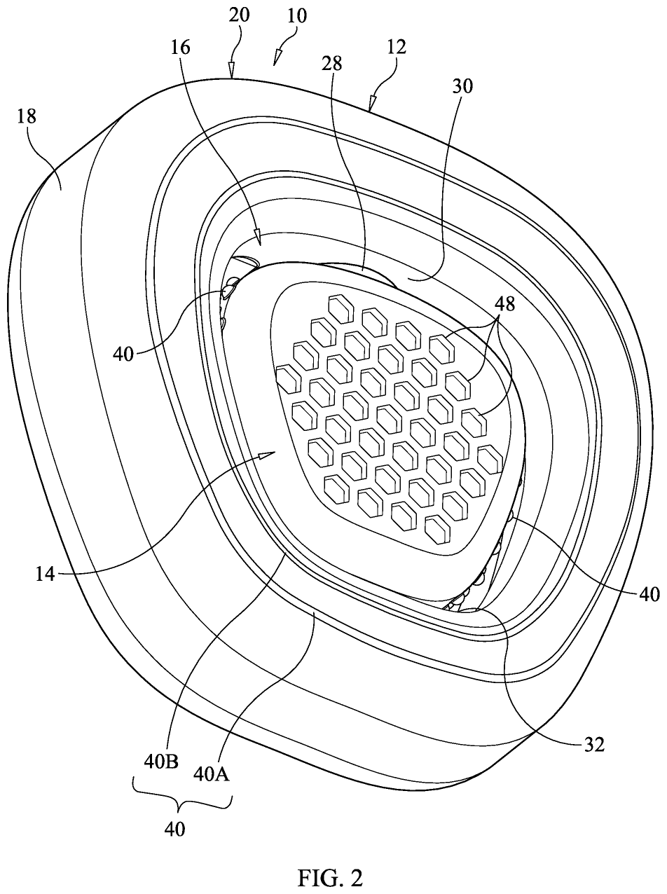

As best seen in FIGS. 1 to 5, the core 14 is rotatable about the rod 28 between an aligned position (FIGS. 2, 3 and 6) and an unaligned position (FIGS. 1, 4 and 5). Alternatively speaking, the core 14 is movable with respect to the housing 12 between the aligned position and the unaligned position.

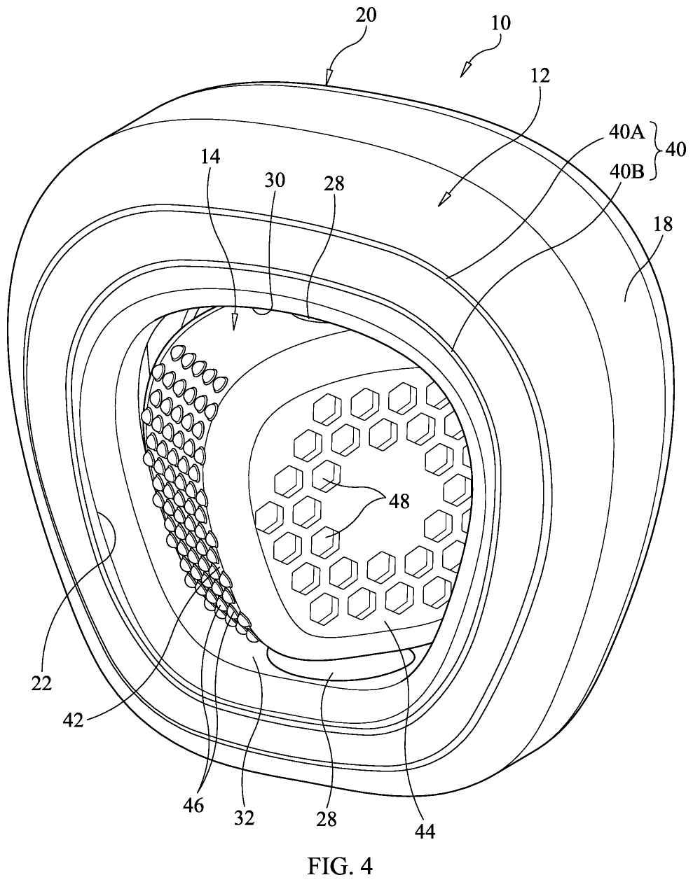

The pocket 24 is restricted by the core 14 when the core 14 and the housing 12 are aligned. That is, the core 14 is disposed in front of the pocket 24 to substantially cover the pocket 24 from the user when the core 14 is aligned with the housing 12, as seen in FIGS. 1 to 3 and 6. The core 14 is offset from the pocket 24 when the core 14 and the housing 12 are unaligned, as seen in FIGS. 4 and 5. In the illustrated embodiment, the unaligned position refers to any range of positions in which the core 14 is offset with respect to the housing 12 such that the pockets 24 are accessible to the pet.

In the illustrated embodiment, the housing 12 further includes at least one groove 40 extending around the central opening 16. In particular, the housing 12 includes a plurality of grooves 40 on the exterior surface 20 of the housing 12. As shown in FIG. 1, the housing 12 includes a pair of inner and outer grooves 40A and 40B extending around the central opening 16. Each of the grooves 40A and 40B is a teething groove for receiving portions of the pet's teeth during use. The grooves 40A and 40B rub against the pet's teeth to clean the teeth while the pet plays with the pet toy 10. It will be apparent to those skilled in the pet products field from this disclosure that the pet toy 10 can include a varying number of teething grooves 40 at different locations around the pet toy 10, as desired. For example, the pet toy 10 can additionally include teething grooves around external sides of the housing 12, such as side surfaces shown in FIGS. 8 and 9.

As best seen in FIGS. 3, 6 and 7, the core 14 includes a pair of first outer surfaces 42 and a pair of second outer surfaces 44. The first outer surfaces 42 are oppositely facing surfaces with respect to each other. The first outer surfaces 42 are connected by the second outer surfaces 44. The second outer surfaces 44 are oppositely facing surfaces with respect to each other. The second outer surfaces 44 are connected by the first outer surfaces 42. The first and second outer surfaces 42 and 44 are connected by curvatures. However, it will be apparent to those skilled in the pet products field from this disclosure that the first and second outer surfaces 42 and 44 can be connected by angles. It will be further apparent to those skilled in the pet products field from this disclosure that the core 14 can be configured as a sphere.

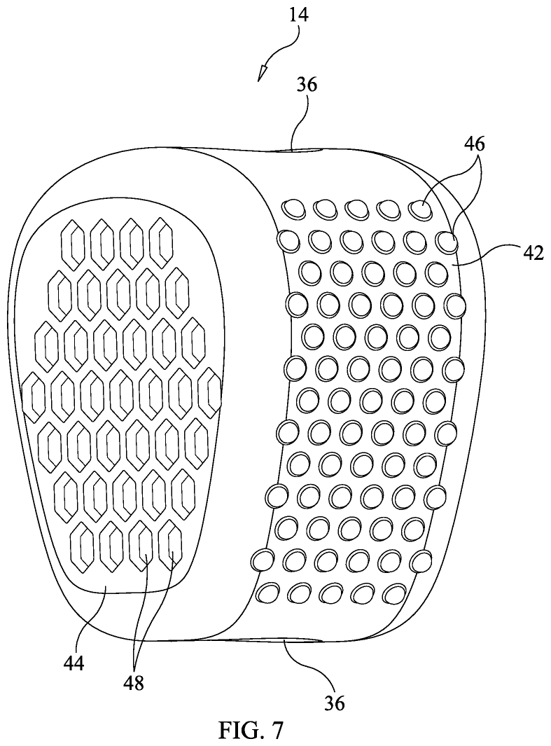

Referring to FIGS. 4, 5 and 7, the core 14 includes a plurality of protrusions 46 projecting from a first outer surface 42 of the core 14. Therefore, the core 14 includes protrusions 46 projecting from at least one of the first and second outer surfaces 42 and 44 of the core 14. In particular, the protrusions 46 have rounded surfaces that project from the first outer surfaces 42, as seen in FIGS. 5 and 7. The protrusions 46 face the pockets 24 when the core 14 is in the aligned position with the housing 12. In the illustrated embodiments, the protrusions 46 are designed to serve as teething nubs. That is, the protrusions 46 are raised nubs on the core 14 that are designed to rub against the pet's teeth and gums to help clean the teeth and gums.

Referring to FIGS. 1 to 4 and 7, the core 14 further comprises a plurality of indents 48 disposed the second outer surfaces 44 of the core 14. Therefore, the indents 48 are also disposed on at least one of the first and second outer surfaces 44 of the core 14. The second outer surfaces 44 face away from pockets 24 when the core 14 is in the aligned position with the housing 12.

The indents 48 of the illustrated embodiments are debossings on the core 14. Therefore, the core 14, made to have messages or patterns that are sunken into the surface of the rubber core 14 through the use of a mold. Therefore, the core 14 includes a plurality of debossings. Toothpaste and peanut butter can be rubbed onto the indents 48 for the pet to lick off. The indents 48 have hexagon-shaped borders in the illustrated embodiment. However, it will be apparent to those skilled in the pet products field from this disclosure that all of the indents 48 can have different and/or varying shapes and sizes.

The indents 48 and the teething nubs of the core 14 help create friction with the pet when the pet engages the pet toy 10. That is, the indents 48 and abutments help create a pet toy 10 of varying surfaces and textures to help enhance the pet's engagement with the pet toy 10.

As described herein embodiments of the invention provide a suitable alternative to a tooth brush for cleaning a dog's tooth. Moreover, as can be understood, embodiments of the present invention have a unique structure and configuration to not only clean teeth but to maintain a dog's interest long enough for their teeth to be cleaned and for ease of cleaning after use.

### GENERAL INTERPRETATION OF TERMS

In understanding the scope of the present invention, the term “comprising” and its derivatives, as used herein, are intended to be open ended terms that specify the presence of the stated features, elements, components and/or groups, but do not exclude the presence of other unstated features, elements, components and/or groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet toy comprising:
a housing having at least one pocket disposed in an interior wall of the housing; and
a core disposed in the housing and movable with respect to the housing between an aligned position with the housing and an unaligned position, the core being disposed in front of the pocket to obstruct external access to the pocket, when the core is in the aligned position and offset from the pocket in the unaligned position.

2. The pet toy according to claim 1, wherein
the housing includes a central opening that defines the interior wall, the core being movably disposed in the central opening.

3. The pet toy according to claim 2, wherein
the housing forming an outer rim around the core.

4. The pet toy according to claim 1, wherein
the housing and the core are both deformable.

5. The pet toy according to claim 4, wherein
the housing is made of vulcanized rubber, and the core is made of vulcanized rubber.

6. The pet toy according to claim 1, wherein
the housing includes a pair of pockets disposed on opposite sides of the central opening with respect to each other.

7. The pet toy according to claim 2, wherein
the housing has a rod extending through the central opening that engages with the core.

8. The pet toy according to claim 7, wherein
the core has a through hole, the rod extending through the through hole so that the core is rotatable with respect to the housing about the rod.

9. The pet toy according to claim 8, wherein
the rod includes an annular flange and the through hole of the core includes an annular depression that engages with the annular flange.

10. The pet toy according to claim 1, wherein
the core includes a plurality of protrusions projecting from at least one outer surface of the core.

11. The pet toy according to claim 1, wherein
the core includes a plurality of indents disposed on at least one outer surface of the core.

12. The pet toy according to claim 1, wherein the core includes a plurality of protrusions projecting from a first outer surface of the core.

13. The pet toy according to claim 12, wherein
the plurality of protrusions face the at least one pocket when the core is in the aligned position with the housing.

14. The pet toy according to claim 12, wherein
the core includes a plurality of indents disposed on a second outer surface of the core.

15. The pet toy according to claim 14, wherein
the second outer surface faces away from the at least one pocket when the core is in the aligned position with the housing.

16. The pet toy according to claim 2, wherein
the housing includes at least one teething groove extending around the central opening.

17. A method of forming a pet toy comprising:
molding a housing from vulcanized rubber, the housing having at least one pocket that is located on an interior wall of the housing;
molding a core from vulcanized rubber; and
installing the core to the housing to dispose the core inside the housing to be movable with respect to the housing between an aligned position with the housing and an unaligned position, the core being disposed in front of the pocket to obstruct external access to the pocket when the core is in the aligned position and offset from the pocket in the unaligned position.
